(19) United States
(12) Patent Application Publication
(10) Pub. No.: US 2009/0244349 A1
(43) Pub. Date: Oct. 1, 2009

(54) SOLID STATE IMAGE PICKUP DEVICE

(76) Inventors: Akio Yamamoto, Toyama (JP); Ichiroh Murakami, Kyoto (JP); Masanori Murakami, Shizuoka (JP)

Correspondence Address: MCDERMOTT WILL & EMERY LLP, 600 13TH STREET, NW, WASHINGTON, DC, 20005-3096, US

(21) Appl. No.: 12/398,527

(22) Filed: Mar. 5, 2009

(30) Foreign Application Priority Data
Mar. 26, 2008 (JP) 2008-080614

(51) Int. Cl. H04N 5/335

(52) U.S. Cl. 348/311; 348/E05.091

(57) ABSTRACT

A solid state image pickup device includes a plurality of light receiving sections formed in a regular pattern, transfer channels, a plurality of first transfer electrodes and a plurality of second transfer electrodes formed on the transfer channels, a plurality of first wires each applying a potential to the corresponding first transfer electrodes and a plurality of second wires each applying a potential to the corresponding second transfer electrodes. The first and second wires extend in the directions intersecting each other.

### CROSS-REFERENCE TO RELATED APPLICATION

This non-provisional application claims priority under 35 U.S.C. §119 (a) of Japanese Patent Application No. 2008-080614 filed in Japan on Mar. 26, 2008, the entire contents of which are hereby incorporated by reference.

### BACKGROUND OF THE INVENTION

The present disclosure relates generally to solid state image pickup devices, particularly to charge coupled device (CCD) solid state image pickup devices.

In the field of CCD solid state image pickup devices, widening of the angle of view, pixel size reduction and high-speed driving have been demanded. The CCD solid state image pickup devices are configured to read signal charges converted from light by light receiving sections and transfer them to an output section. Therefore, a potential needs to be periodically applied as a transfer pulse to transfer electrodes arranged on transfer channels.

The transfer electrodes may be configured as multi-layered transfer electrodes in which adjacent transfer electrodes overlap each other or single-layered transfer electrodes in which adjacent transfer electrodes do not overlap each other. With a recent trend toward finer design rules of the solid state image pickup devices, the size of a single pixel has been reduced to about 1.7 μm. Accordingly, the single-layered transfer electrodes are generally employed to reduce the height of surrounding parts of the pixels and reduce vignetting of an incident light.

Conventionally, three or more transfer electrodes have been allocated per pixel. But recently, two transfer electrodes, i.e., a transfer electrode and another transfer electrode also serving as a read electrode, are generally used. Although size reduction of the transfer electrodes is required in response to the pixel size reduction, this is for the purpose of increasing an area of the transfer electrodes per pixel so that a certain amount of charges can be accumulated in a single transfer electrode.

In general, when a resistance of the transfer electrodes is increased, a potential pulse applied to the edge of the transfer electrode becomes less sharp or is delayed, and the signal charges of the pixels at the center of the sensor may not suitably be read out. This phenomenon occurs significantly when the transfer electrodes are elongated due to the widening of the angle of view, when the transfer electrodes are narrowed due to the pixel size reduction and when a high frequency transfer pulse is applied for high-speed transfer.

A technique of suppressing the potential pulse from becoming less sharp or delayed by forming wires made of a low resistance material (so-called low resistance wires) and connecting them to the transfer electrodes has been established to avoid the increase in resistance of the transfer electrodes and to achieve the widening of the angle of view, the pixel size reduction and the high-speed driving. For example, the low resistance wires are formed to extend along a transfer direction and the wires are periodically connected to the transfer electrodes or the transfer electrodes also serving as the read electrodes (e.g., see Japanese Patent Gazette No. 3160915).

There is also a known technique of forming the low resistance wires on the horizontally arranged transfer electrodes and periodically connecting the wires to the transfer electrodes or the transfer electrodes also serving as the read electrodes. According to this method, the increase in resistance of the transfer electrodes can be suppressed and restrictions on transfer modes can be avoided (e.g., see Japanese Published Patent Application No. 2006-41369).

Further, in relation to a CCD solid state image pickup device in which three transfer electrodes are provided per pixel, another known technique of forming the low resistance wires extending in the transfer direction and a direction intersecting with the transfer direction to realize high speed driving and reduce interception of incident light has been disclosed (e.g., see Japanese Published Patent Application No. 10-22497). In this case, the low resistance wires corresponding to some of the transfer electrodes may not be formed (e.g., see Japanese Published Patent Application No. 2006-86350).

### SUMMARY OF THE INVENTION

In the future, as to the solid state imaging pickup devices having ten million or more pixels, a flexible transfer mode and high speed driving which allow still picture imaging and video recording will be required. Therefore, for the solid state image pickup devices, it is essential that the transfer electrodes are formed in a single layer, a transfer electrode and another transfer electrode also serving as a read electrode are provided per pixel, and the low resistance wires for supplying a potential to the transfer electrodes are provided.

According to the conventional method of forming the low resistance wires along the transfer direction and connecting the wires periodically to the transfer electrodes or the transfer electrodes also serving as the read electrodes, the signal charge transfer modes are restricted. Therefore, this method is not suitable for multiphase driving applied to selective transfer for the video recording.

According to the conventional method of forming the low resistance wires on the transfer electrodes, the potential has to be applied separately to the transfer electrodes and the transfer electrodes also serving as the read electrodes. Therefore, two wires have to be formed in the same layer on the transfer electrodes. The two wires will be difficult to form as the size of the pixels is reduced.

Further, the CCD solid state image pickup device having three or more transfer electrodes per pixel is disadvantageous from the viewpoint of the size reduction of the transfer electrodes in response to the pixel size reduction.

The present disclosure is directed to realize a solid state image pickup device having two single-layered transfer electrodes per pixel and ready for a flexible transfer mode and high speed driving.

For this purpose, the present disclosure offers a solid state image pickup device having first wires and second wires extending in directions intersecting with each other.

More specifically, the disclosed solid state image pickup device includes: a plurality of light receiving sections formed in a regular pattern in a semiconductor substrate; transfer channels formed in the semiconductor substrate to extend in a first direction between the light receiving sections; a plurality of first transfer electrodes formed on the transfer channels; a plurality of second transfer electrodes formed on the transfer channels in the same layer in which the first transfer electrodes are formed, each of the second transfer electrodes serving as a read electrode for reading charges accumulated in the corresponding light receiving section to the corresponding transfer channel; a plurality of first wires each applying a potential to the corresponding first transfer electrodes; and a plurality of second wires each applying a potential to the corresponding second transfer electrodes and extending in a direction intersecting with the first wires.

In the disclosed solid state image pickup device, the widths of the first and second wires are made almost equal to the width of the transfer electrodes. Therefore, the increase in resistance of the wires can be prevented, the potential pulse is suppressed from becoming less sharp or delayed, and the wire formation becomes easy. If a material having a resistivity lower than that of polysilicon is used to form the wires, the less sharp or delayed potential pulse is much less likely to occur.

### BRIEF DESCRIPTION OF THE DRAWINGS

FIG. 1 is a plan view of an example solid state image pickup device.

FIG. 2 is a sectional view of the example solid state image pickup device taken along the line II-II of FIG. 1.

FIG. 3 is a sectional view of the example solid state image pickup device taken along the line III-III of FIG. 1.

FIG. 4 is a sectional view of the example solid state image pickup device taken along the line IV-IV of FIG. 1.

FIG. 5 is a plan view of a first modification of the example solid state image pickup device.

FIG. 6 is a plan view of a second modification of the example solid state image pickup device.

FIG. 7 is a sectional view of the second modification of the example solid state image pickup device taken along the line VII-VII of FIG. 6.

FIG. 8 is a sectional view of the second modification of the example solid state image pickup device taken along the line VIII-VIII of FIG. 6.

FIG. 9 is a sectional view of the second modification of the example solid state image pickup device taken along the line IX-IX of FIG. 6.

### DETAILED DESCRIPTION OF THE INVENTION

### Embodiment

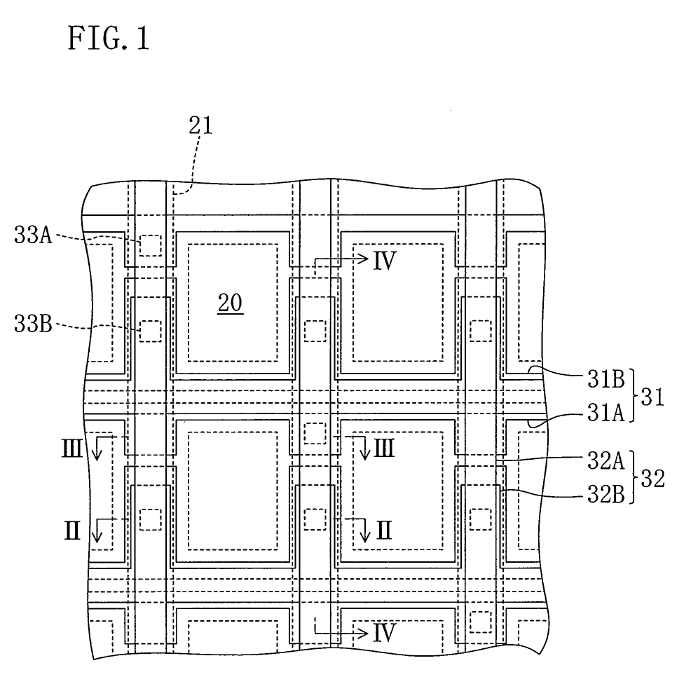

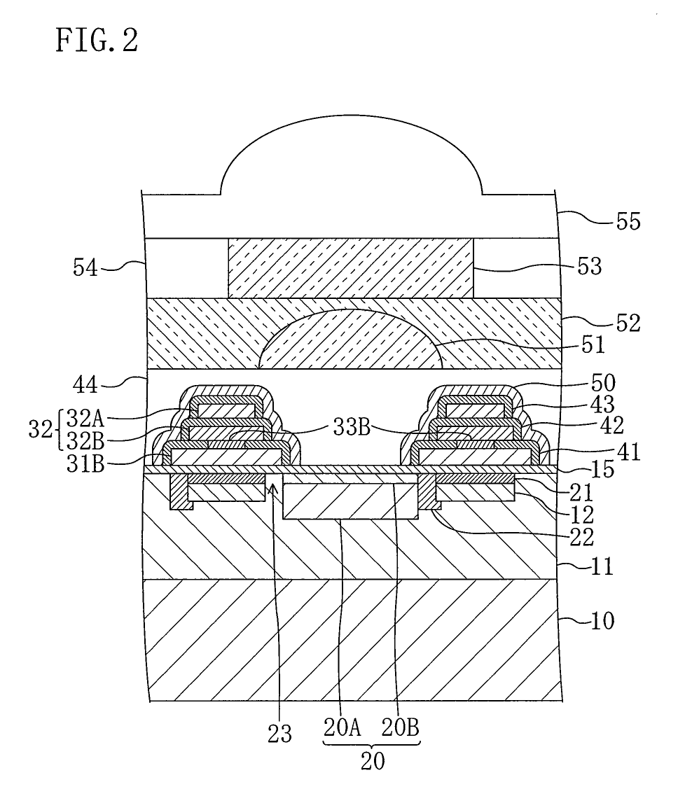

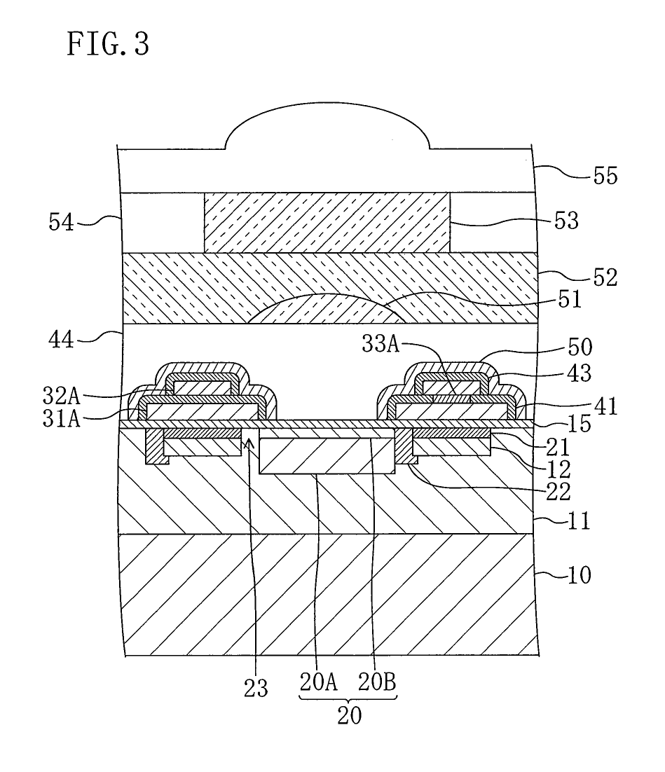

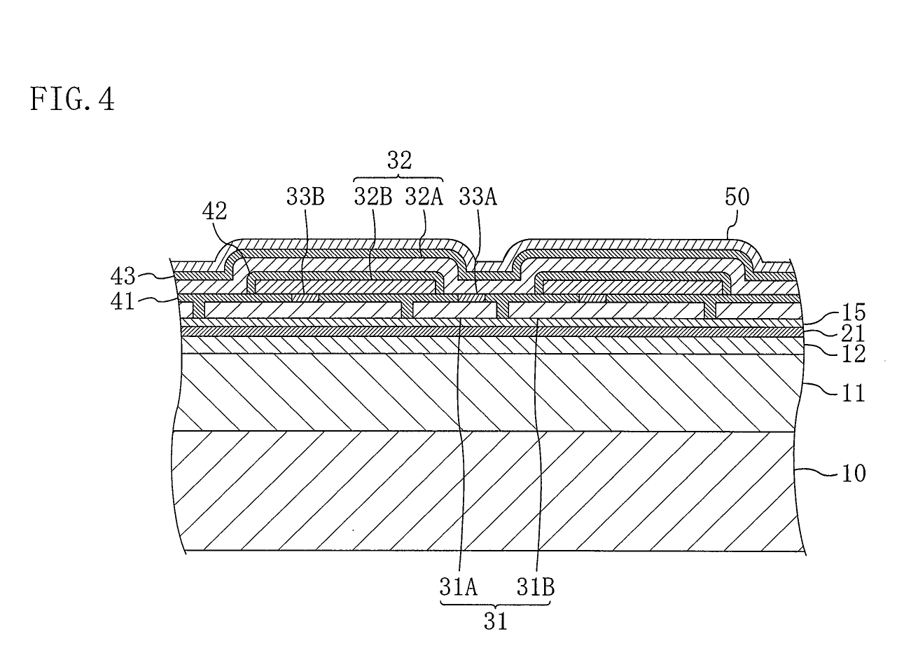

An example embodiment of the present invention will be explained with reference to the drawings. FIG. 1 shows the structure of an example solid state image pickup device in a plan view. FIG. 2 shows the same structure in a sectional view taken along the line II-II of FIG. 1, FIG. 3 shows the same structure in a sectional view taken along the line III-III of FIG. 1 and FIG. 4 shows the same structure in a sectional view taken along the line IV-IV of FIG. 1.

As shown in FIGS. 1-4, the example solid state image pickup device is a four-phase driving CCD. A plurality of light receiving sections 20 are formed in a matrix pattern in a semiconductor substrate 10. A plurality of transfer channels 21 are formed in the semiconductor substrate 10 to extend in a first direction between the light receiving sections 20. Transfer electrodes 31 are formed on the transfer channels 21 at intervals from each other. The transfer electrodes 31 include first transfer electrodes 31A and second transfer electrodes 31B also serving as read electrodes. The first and second transfer electrodes 31A and 31B are alternately arranged not to overlap each other. In this embodiment, the first transfer electrodes 31A adjacent to each other in a second direction intersecting with the first direction are connected to each other at portions passing between the light receiving sections 20, so are the second transfer electrodes 31B.

A plurality of wires 32 for supplying a potential to the transfer electrodes 31 are formed on the transfer electrodes 31. The wires 32 include first wires 32A extending in the first direction and second wires 32B extending in the second direction. The first wires 32A are connected to the first transfer electrodes 31A through plugs 33A. The second wires 32B are connected to the second transfer electrodes 31B through plugs 33B. The first transfer electrodes 31A adjacent to each other in the first direction are connected to different first wires 32A.

The light receiving sections 20 are photodiodes each having an n-type region 20A and a p-type region 20B formed in a first p-well 11 formed in an upper portion of the n-type silicon semiconductor substrate 10. The transfer channels 21 are n-type regions formed in second p-wells 12 formed at intervals from the light receiving sections 20.

P-type channel stops 22 partially surrounding the light receiving sections 20 are formed to prevent signal charges from coming in and out between the adjacent light receiving sections 20.

The first transfer electrodes 31A and the second transfer electrodes 31B are made of polysilicon formed on the semiconductor substrate 10 with an insulating film 15 interposed therebetween. The insulating film 15 functions as a gate insulating film of the transfer electrodes 31. The first and second transfer electrodes 31A and 31B may be about 100 nm in thickness. Regions between the light receiving sections 20 and the transfer channels 21 where the channel stops 22 are not formed serve as read gates 23 controlled by the second transfer electrodes 31B to read signal charges accumulated in the light receiving sections 20. From the viewpoint of signal charge reading, the second transfer electrodes 31B may preferably be longer than the first transfer electrodes 31A in the first direction.

The second wires 32B and the first wires 32A are formed on the first transfer electrodes 31A and the second transfer electrodes 31B. The first and second wires 32A and 32B may preferably be made of polysilicon or a material having a resistivity lower than that of polysilicon, for example, tungsten, aluminum or metal silicide. In this case, the first and second wires 32A and 32B may be about 100 nm in thickness.

The first and second transfer electrodes 31A and 31B are covered with a first insulating film 41 made of silicon oxide (SiO₂) or the like. The second wires 32B and the first transfer electrodes 31A are insulated from each other, while the second wires 32B and the corresponding second transfer electrodes 31B are electrically connected through the plugs 33B penetrating the first insulating film 41.

The second wires 32B are covered with a second insulating film 42 made of SiO₂ or the like. Therefore, the first wires 32A, the second wires 32B and the second transfer electrodes 31B are insulated from each other. The first wires 32A and the corresponding first transfer electrodes 31A are electrically connected through the plugs 33A penetrating the first insulating film 41. The first wires 32A are covered with a third insulating film 43 made of SiO₂ or the like.

A light shielding film 50 made of tungsten or the like is formed to prevent light from entering the transfer channels 21. The light shielding film 50 is formed to cover the first transfer electrodes 31A, the second transfer electrodes 31B, the first wires 32A and the second wires 32B. The first and second transfer electrodes 31A and 31B are covered with the first insulating film 41, the second wires 32B are covered with the second insulating film 42 and the first wires 32A are covered with the third insulating film 43. Thus, they are insulated from the light shielding film 50.

A fourth insulating film 44 is formed on the light shielding film 50 to smooth the difference in level caused by the first transfer electrodes 31A, the second transfer electrodes 31B, the first wires 32A and the second wires 32B. The fourth insulating film 44 may be made of a borophosphosilicate glass (BPSG) film or the like.

In-layer lenses 51 made of SiO₂ or silicon nitride (SiN) are formed on the fourth insulating film 44 to come above the light receiving sections 20, respectively. A first planarization layer 52 made of a resin having high transmittance to visible light is formed to smooth valleys formed between the lenses. Color filters 53 of R (red), G (green) and B (blue) are formed on the first planarization layer 52 to come above the in-layer lenses 51, respectively. The G filters are arranged in a checkers pattern and the R and B filters are arranged alternately between the G filters. The color filters 53 are not limited to the RGB filters and complementary color filters may also be used. A second planarization layer 54 is formed to smooth the difference in level caused by the color filters 53 and on-chip lenses 55 are formed on the color filters 53.

Hereinafter, an example method of driving the example solid state image pickup device will be explained. First, for reading signal charges from a certain light receiving section 20 to the transfer channel 21, a read pulse φVR is applied to the second transfer electrode 31B corresponding to the target light receiving section 20 through the second wire 32B. For example, a potential of the read pulse φVR may be 12 V. The other second transfer electrodes 31B are set to a low potential level. The first transfer electrode 31A corresponding to the target light receiving section 20 is set to a high potential level, while the other first transfer electrodes 31A are set to a low potential level. The high and low potential levels may be 0 V and −6 V, respectively.

As a result, a potential depth of the transfer channel 21 becomes ready for receiving the signal charges from the light receiving region 20. As a potential of a read gate 23 varies, the signal charges from the light receiving section 20 are read to the transfer channel 21.

Then, transfer pulses φV1 to φV4 corresponding to the four phase driving are applied at predetermined timing to the first and second transfer electrodes 31A and 31B.

The transfer pulses φV1 to φV4 may be, for example, −6 V to 0 V. As a result, the signal charges read by the transfer channel 21 are transferred within the transfer channel 21. Then, they are transferred horizontally by a horizontal transfer section (not shown) and converted to a voltage corresponding to the signal charge amount and output by an output section (not shown).

The example solid state image pickup device has a single-layered transfer electrode structure in which the first transfer electrodes 31A and the second transfer electrodes 31B also serving as read electrodes are formed of a single polysilicon layer. It also has the first wires 32A extending in the first direction parallel to the transfer channels and supplying drive pulses to the first transfer electrodes 31A and the second wires 32B extending in the direction intersecting with the first direction and supplying drive pulses to the second transfer electrodes 31B. Since the first and second wires 32A and 32B extend in the different directions, the widths of the first and second wires 32A and 32B can be made almost equal to the width of the transfer electrodes. Therefore, a less sharp or delayed transfer pulse is less likely to occur.

As the wires are increased in width, they can be thinned down. Therefore, the vignetting of light entering the light receiving sections can be reduced. Different from the structure in which the transfer electrodes are layered and extend in the same direction, the total height is not increased. The wires can be thinned down to a further extent if they are made of a material having a resistivity lower than that of polysilicon. For example, commonly used polysilicon has a resistivity of about 1×10⁻⁴ Wcm. If tungsten having a resistivity of about 5×10⁻⁹ Wcm is used, the wire thickness can be reduced to 150 nm or less.

Since the first wires 32A and the second wires 32B are formed independently from each other, the transfer pulses can be applied to the first transfer electrodes 31A and the second transfer electrodes 31B separately from each other. This makes it possible to adopt a flexible transfer mode applied to selective transfer for the video recording.

### First Modification of Embodiment

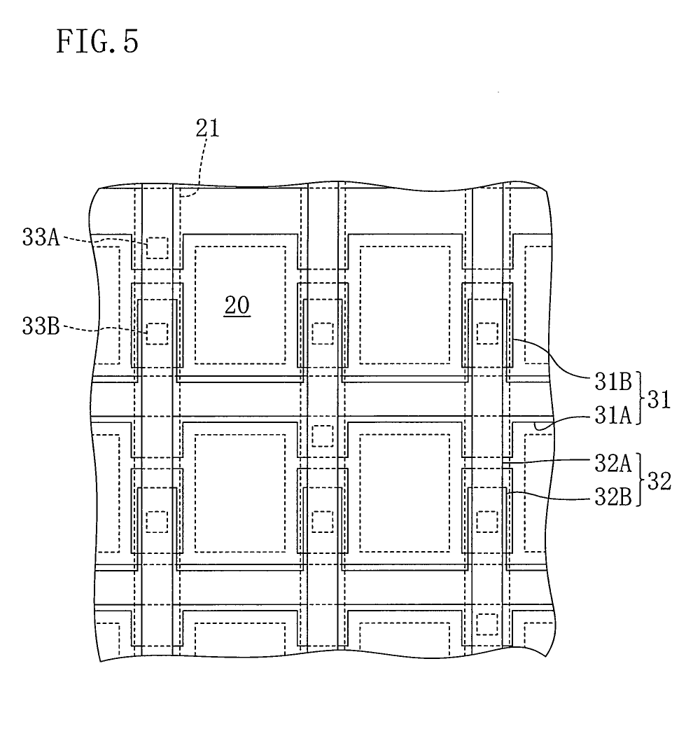

Hereinafter, a first modification of the example solid state image pickup device will be explained with reference to the drawing. FIG. 5 shows the structure of the first modification of the example solid state image pickup device in a plan view. In FIG. 5, the same components as those shown in FIG. 1 are indicated by the same reference numerals to omit the explanation.

In the first modification of the example solid state image pickup device, the second transfer electrodes 31B are formed independently from each other and the second transfer electrodes 31B adjacent to each other in the second direction are electrically connected through the second wires 32B formed in a layer above the transfer electrodes 31. This structure makes it possible to prevent the application of the read pulse φVR to the channel stops 22 formed between the light receiving sections 20 adjacent to each other in the first direction. Therefore, when the read pulse φVR is applied, color mixing is less likely to occur between the light receiving sections 20 adjacent to each other in the first direction.

### Second Modification of Embodiment

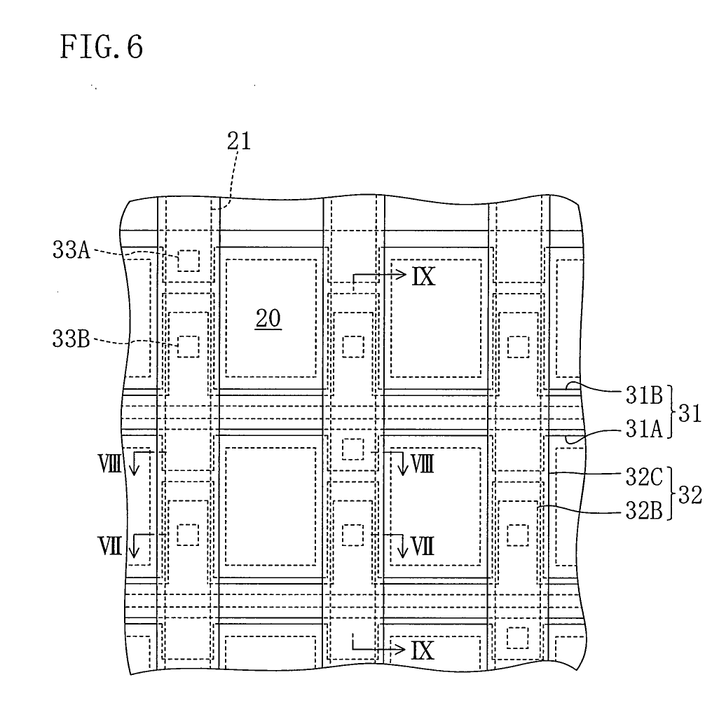

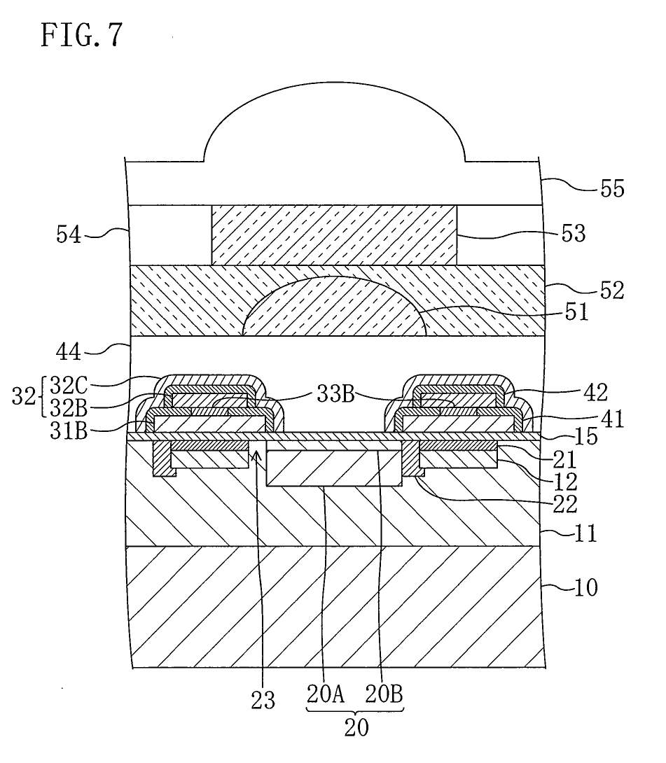

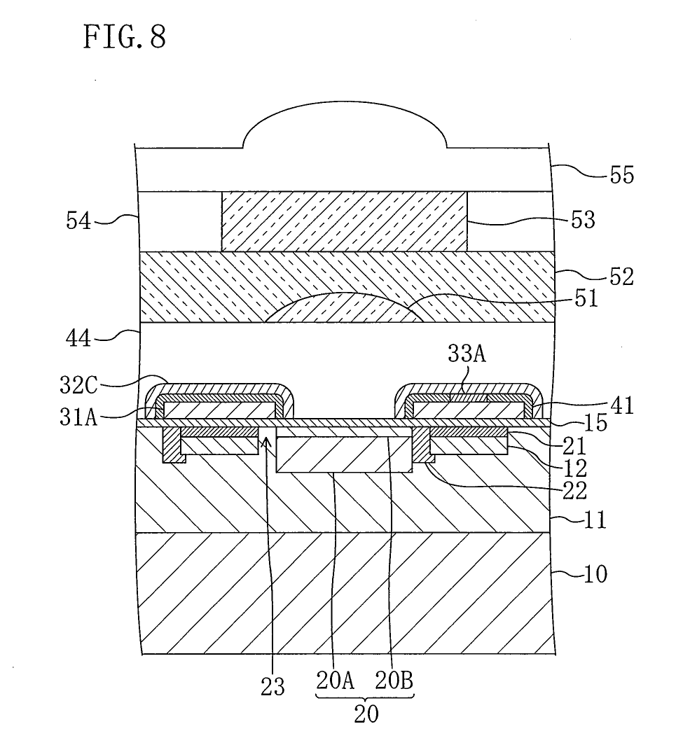

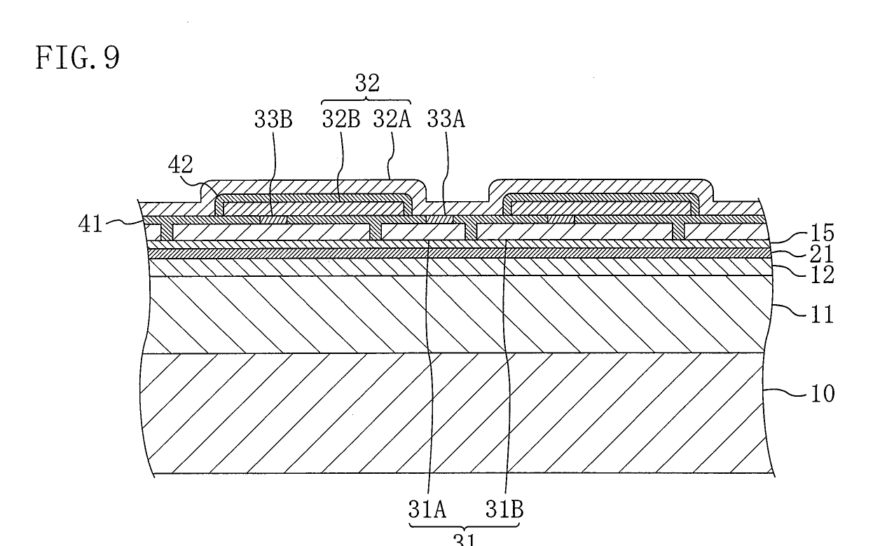

Hereinafter, a second modification of the example solid state image pickup device will be explained with reference to the drawings. FIG. 6 shows the structure of the second modification of the example solid state image pickup device in a plan view. FIG. 7 shows the same structure in a sectional view taken along the line VII-VII of FIG. 6, FIG. 8 shows the same structure in a sectional view taken along the line VIII-VIII of FIG. 6 and FIG. 9 shows the same structure in a sectional view taken along the line IX-IX of FIG. 6. In FIGS. 6-9, the same components as those shown in FIGS. 1-4 are indicated by the same reference numerals to omit the explanation.

In the second modification of the example solid state image pickup device, first wires 32C function as a light shielding film which prevents the light from entering the transfer channels 21. The first wires 32C also serving as the light shielding film are in contact with an insulating film 15 covering the light receiving sections 20. Therefore, when a drive pulse is applied to the first wires 32C, an electric field generated from the edges of the first wires 32C may possibly have an effect on the potential of the light receiving sections 20 through the insulating film 15.

In a conventional solid state image pickup device, a read pulse φVR, a high-level transfer pulse and a low-level transfer pulse need to be applied to the wires also serving as the light shielding film. The read pulse φVR, the high-level transfer pulse and the low-level transfer pulse may be, for example, 12 V, 0 V and −6 V having different potentials. The wires to which the pulses of different potentials are applied generate electric fields of different intensities. Therefore, the potential of the light receiving sections 20 may be affected and the reading efficiency may vary. In the case of a CCD in which the signal charges are successively transferred, the pulses of different potentials are applied periodically to the wires. Therefore, periodical noises may occur.

In the second modification of the example solid state image pickup device, however, the second wires 32B extending in the second direction are provided. The read pulse φVR is applied only to the second wires 32B but not to the first wires 32C also serving as the light shielding film. That is, two different electric fields are generated from the edges of the first wires 32C also serving as the light shielding film. Accordingly, as compared with a known technique of forming low resistance wires extending only in the first direction, the effect on the potential by the edges of the light receiving sections 20 is reduced. Thus, image quality is less likely to deteriorate.

In the above-described embodiment and modifications, the light receiving sections 20 are arranged in a matrix pattern. However, they may be arranged in other patterns than the matrix as long as they are regularly arranged. Not only to the above-described interline transfer solid state image pickup devices, the disclosed technology may also be applicable to frame interline transfer solid state image pickup devices.

The present disclosure allows providing a solid state image pickup device having two single-layered transfer electrodes per pixel and ready for a flexible transfer mode and high speed driving. The present disclosure is particularly useful in the field of CCD solid state image pickup devices.

What is claimed is:

1. A solid state image pickup device comprising:
a plurality of light receiving sections formed in a regular pattern in a semiconductor substrate;
transfer channels formed in the semiconductor substrate to extend in a first direction between the light receiving sections;
a plurality of first transfer electrodes formed on the transfer channels;
a plurality of second transfer electrodes formed on the transfer channels in the same layer in which the first transfer electrodes are formed, each of the second transfer electrodes serving as a read electrode for reading charges accumulated in the corresponding light receiving section to the corresponding transfer channel;
a plurality of first wires each applying a potential to the corresponding first transfer electrodes; and
a plurality of second wires each applying a potential to the corresponding second transfer electrodes and extending in a direction intersecting with the first wires.

2. The solid state image pickup device of claim 1, wherein
the first wires extend in the first direction and the second wires extend in a second direction.

3. The solid state image pickup device of claim 2, wherein
the first transfer electrodes adjacent to each other in the second direction are integrated and
the second transfer electrodes adjacent to each other in the second direction are integrated.

4. The solid state image pickup device of claim 3, wherein
the first transfer electrodes adjacent to each other in the first direction are connected to the different first wires.

5. The solid state image pickup device of claim 2, wherein
the first transfer electrodes adjacent to each other in the second direction are integrated and
the second transfer electrodes adjacent to each other in the second direction are independent from each other.

6. The solid state image pickup device of claim 5, wherein
the first transfer electrodes adjacent to each other in the first direction are connected to the different first wires.

7. The solid state image pickup device of claim 1, wherein
at least one of the first wires and the second wires are made of polysilicon or a material having a resistivity lower than that of polysilicon.

8. The solid state image pickup device of claim 7, wherein
the material having a resistivity lower than that of polysilicon is tungsten, aluminum or metal silicide.

9. The solid state image pickup device of claim 1, wherein
the first wires also serve as a light shielding film for preventing light from entering the transfer channels.
